(19) United States
(12) Patent Application Publication
(10) Pub. No.: US 2025/0324009 A1
(43) Pub. Date: Oct. 16, 2025

(54) INFORMATION PROCESSING APPARATUS AND CONFIGURATION METHOD

(71) Applicant: SHARP KABUSHIKI KAISHA, Sakai City (JP)

(72) Inventor: HIDEKI SETO, Sakai City (JP)

(21) Appl. No.: 19/095,946

(22) Filed: Mar. 31, 2025

(30) Foreign Application Priority Data
Apr. 12, 2024 (JP) 2024-064869

(51) Int. Cl. H04N 1/00; H04N 1/44

(52) U.S. Cl. CPC H04N 1/0097; H04N 1/00204; H04N 1/00334; H04N 1/00973; H04N 1/4413; H04N 2201/0094

(57) ABSTRACT

An information processing apparatus includes a storage that stores system configuration information, an acquirer that acquires input information generated in a terminal device, and a one or more controllers that perform system configuration processing based on the system configuration information. Based on the input information acquired from the terminal device, the one or more controllers store the system configuration information and performs system configuration processing.

### CROSS REFERENCE TO RELATED APPLICATION

This application claims priority from Japanese Patent Application No. 2024-064869 filed on Apr. 12, 2024. The entire contents of the priority application are incorporated herein by reference.

### TECHNICAL FIELD

The disclosure relates to an information processing apparatus and the like.

### BACKGROUND ART

For example, a known information processing apparatus performs an initial configuration at the time of initial activation of the information processing apparatus in a factory shipment state.

### SUMMARY

### Technical Problem

An object of the disclosure is to provide, for example, for an information processing apparatus requiring an initial configuration, an information processing apparatus and the like that improve usability of the initial configuration.

### Solution to Problem

According to the disclosure, an information processing apparatus includes a storage that stores system configuration information, an acquirer that acquires input information generated in a terminal device, and one or more controllers that perform system configuration processing, based on the system configuration information. Upon acquiring the input information, the one or more controllers store the system configuration information and perform the system configuration processing, based on the input information.

According to the disclosure, a configuration method includes a storage step of storing system configuration information, an acquisition step of acquiring input information generated in a terminal device, and a control step of performing system configuration processing based on the system configuration information. In the control step, when the input information is acquired, based on the input information, the system configuration information is stored and the system configuration processing is performed.

### Advantageous Effects of Disclosure

According to the disclosure, for example, for an information processing apparatus requiring an initial configuration, an information processing apparatus and the like can be provided that improve the usability of the initial configuration.

### BRIEF DESCRIPTION OF THE DRAWINGS

FIG. 1 is a diagram for describing an overview of a configuration system according to a first embodiment.

FIG. 2 is a diagram for describing a hardware configuration of an information processing apparatus and a terminal according to the first embodiment.

FIGS. 3A and 3B are diagrams for describing a software configuration according to the first embodiment.

FIGS. 4A and 4B are diagrams for describing an example of a system configuration and an example of input information according to the first embodiment.

FIG. 5 is a diagram for describing a flow of processing according to the first embodiment.

FIG. 6 is a diagram for describing a flow of processing according to the first embodiment.

FIGS. 7A to 7E are diagrams for describing an operation example according to the first embodiment.

FIGS. 8A and 8B are diagrams for describing an operation example according to the first embodiment.

FIG. 9 is a diagram for describing a flow of processing according to a second embodiment.

FIGS. 10A and 10B are diagrams for describing an operation example according to the second embodiment.

FIG. 11 is a diagram for describing a flow of processing according to a third embodiment.

FIG. 12 is a diagram for describing a flow of processing according to the third embodiment.

FIGS. 13A and 13B are diagrams for describing an operation example according to the third embodiment.

FIG. 14 is a diagram for describing a flow of processing according to a fourth embodiment.

FIGS. 15A and 15B are diagrams for describing an operation example according to the fourth embodiment.

FIG. 16 is a diagram for describing a flow of processing according to a fifth embodiment.

FIG. 17 is a diagram for describing a flow of processing according to the fifth embodiment.

### DETAILED DESCRIPTION OF THE INVENTION

In general, in an information processing apparatus, a controller executes various configurations of the information processing apparatus. The controller stores information for executing various configurations in a storage as system configuration information. For an image forming device including an information processing apparatus, during initial introduction (initial activation) of the image forming device in a factory shipment state or the like, a user needs to perform configuration by using a large amount of system configuration information as an initial configuration.

In such an initial configuration, a large number of characters need to be displayed, and a complicated operation is often required. For example, such an operation includes display of a user consent form, a language configuration, a password configuration, a network configuration, a function configuration, or the like. At this time, in an image forming device including a small operation screen (for example, not an operation screen having a size of about 10 inches but an operation screen having a size of about 4 inches), reading many characters, performing a complicated operation, or the like may be difficult.

Hereinafter, with reference to the drawings, an information processing apparatus of the disclosure will be described in connection with embodiments. Note that the disclosure set forth in the claims will be described in the embodiments below as an example, and the technical scope of the disclosure is not limited to the following description.

### 1. First Embodiment

Hereinafter, the first embodiment will be described. Note that the first embodiment will be described using the following as an example. In the following embodiment, a case will be described where an information processing apparatus of the disclosure is applied to an image forming device. However, the information processing apparatus may be applied to other devices.

### 1.1 Entirety of System

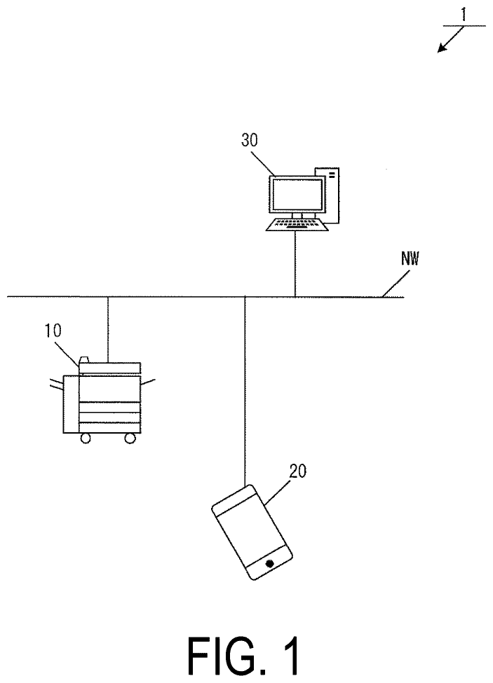

FIG. 1 is a diagram for describing an overview of a system 1 including an image forming device 10.

The system 1 includes an image forming device 10 and one or multiple mobile terminal devices 20 and terminal devices 30 that can communicate with one another via a network (NW).

The image forming device 10 is a device referred to as, for example, a multifunction printer or a Multifunction Peripheral/Printer/Product (MFP). For example, when executing a job (print job), the image forming device 10 can form an image on paper which is a recording medium. The image forming device 10 can execute a job for multiple processing operations such as copy processing, FAX processing, scan processing, and print processing, as a job to be executed.

The mobile terminal device 20 is, for example, a first terminal device including an information processing apparatus, such as a smartphone, a tablet, or a notebook computer. The mobile terminal device 20 is preferably a portable device that can be carried by a user. The mobile terminal device 20 may be connected to the image forming device 10 via a wireless LAN, or may be connected to the image forming device 10 using near field communication. That is, the mobile terminal device 20 and the image forming device 10 can be connected and communicate with each other using any communication unit.

The terminal device 30 is, for example, a second terminal device used by a user or an administrator. For example, the terminal device 30 transmits a print job to the image forming device 10. By executing the received print job, the image forming device 10 performs printing on a recording sheet based on print data, for example. By accessing the image forming device 10 from the terminal device 30, the administrator can, for example, configure the image forming device 10.

The terminal device 30 is included in the system 1 as necessary. For example, the system may include one terminal device 30 or multiple terminal devices 30. The terminal device 30 may be a server device, a network camera, or a home appliance (for example, a television, a video camera, an air conditioner, or the like) corresponding to IoT.

The network (NW) connecting the image forming device 10, the mobile terminal device 20, and the terminal device 30 may be any communication line or communication system and may use a Local Area Network (LAN), a Virtual Local Area Network (VLAN), the Internet, or a public line network, or a communication system such as mobile communication (for example, mobile communication such as 4G/5G/6G) or a next-generation telephone network.

In the system 1, the image forming device 10 and the mobile terminal device 20 can exchange information by using code information. Note that first code information refers to code information (transmission code information) used to transmit information from the image forming device 10 to the mobile terminal device 20, and second code information (reception code information) refers to code information used by the image forming device 10 to receive information from the mobile terminal device 20.

### 1.2 Hardware Configuration

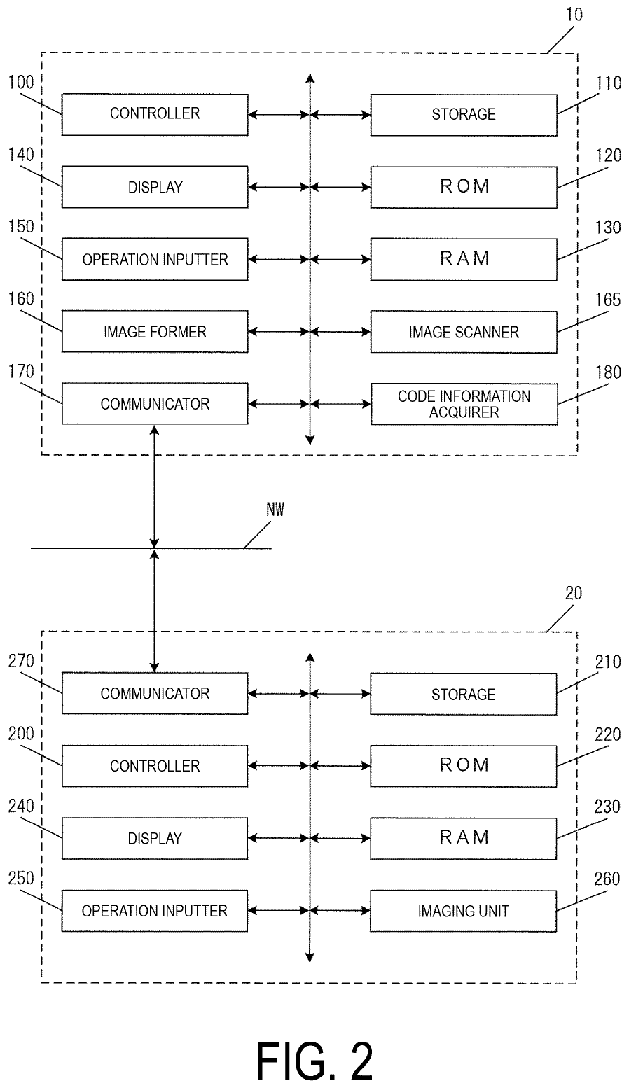

With reference to the drawings, description will be given of a hardware configuration of the image forming device 10 and the mobile terminal device 20, which are representative of the devices of the system 1. FIG. 2 is a diagram illustrating an example of the image forming device 10 and the mobile terminal device 20.

### 1.2.1 Image Forming Device 10

As illustrated in FIG. 2, the image forming device 10 includes a controller 100, a storage device (storage) including a storage 110, a ROM 120, and a RAM 130, a display 140, an operation inputter 150, an image former 160, an image scanner 165, a communicator 170, and a code information acquirer 180.

The controller 100 controls an entirety of the image forming device 10. The controller 100 implements various functions by reading and performing various programs stored in the storage device (for example, the storage 110 and the ROM 120). The controller 100 may be implemented by one or multiple control devices/arithmetic devices (such as a Central Processing Unit (CPU), a System on a Chip (SoC)). The controller 100 may include one or multiple control circuits.

The storage 110 is a non-volatile storage device capable of storing programs and data. For example, the storage 110 may include one or multiple storage devices such as a Hard Disk Drive (HDD) or a Solid State Drive (SSD). The storage 110 may be configured as an external device such as a USB memory that can be connected to the image forming device 10. The storage 110 may be, for example, a storage area on a cloud.

The ROM 120 is a non-volatile memory capable of holding the program and data even in a case that the power is turned off.

The RAM 130 is a main memory mainly used when the controller 100 executes processing. The RAM 130 is a rewritable memory that temporarily holds a program read from the storage 110 or the ROM 120 and data including an execution result.

The display 140 is a display device that can display various types of information and various screens such as an execution screen. The display 140 may be, for example, a display device such as a Liquid Crystal Display (LCD), an Organic Electro-Luminescence (EL) display, or an electrophoresis display. The display 140 includes an interface to which the display device can be connected. For example, the display 140 may include an external display device connected via a High-Definition Multimedia Interface (HDMI) (trade name), a Digital Visual Interface (DVI), or a Display Port.

The operation inputter 150 is an operation device that allows a user to input an operation. For example, the operation inputter 150 may be software keys displayed on a touch panel integrated with the display 140 or hardware keys such as operation buttons. The operation inputter 150 may be an operation device such as a keyboard or a mouse. The operation inputter 150 may also include an interface (for example, a Universal Serial Bus (USB)) to which an operation device can be connected. For example, the image forming device 10 may be connected to different operation devices (a keyboard, a mouse, and the like) via an interface.

The image former 160 forms an image on, for example, a recording sheet. The image former 160 includes, for example, an image carrier, and forms an image by forming a toner image on the image carrier and transferring the toner image on the image carrier onto the recording sheet. The image former 160 may be configured as an image forming device such as a printer. The image former 160 may electronically form an image as an image file.

The image scanner 165 scans a document (image) and outputs the document as image data. The image scanner 165 is, for example, a scanner, and may be a scanning device using a Charge Coupled Device (CCD), a Contact Image Sensor (CIS), or a Complementary Metal-Oxide-Semiconductor (CMOS) image sensor.

The communicator 170 is a communication interface that communicates with other devices. The communicator 170 may be, for example, a network interface capable of providing wired connection or wireless connection. In the present embodiment, communication with other devices is available via a network NW.

The code information acquirer 180 acquires predetermined information (for example, code information in the present embodiment) from the mobile terminal device 20. The code information acquirer 180 can scan by, for example, an optical means, the second code information (for example, a two dimensional code or the like) displayed on the mobile terminal device 20. The code information acquirer 180 may acquire the second code information from the mobile terminal device 20 using another method, for example, Near field communication (NFC). In the present embodiment, the code information acquirer 180 is described as a single configuration, but may be implemented by using, for example, the image scanner 165.

### 1.2.2 Mobile Terminal Device 20

As illustrated in FIG. 2, the mobile terminal device 20 includes a controller 200, a storage device (storage) including a storage 210, a ROM 220, and a RAM 230, a display 240, an operation inputter 250, an imaging unit 260, and a communicator 270.

The controller 200 controls the entirety of the mobile terminal device 20. The controller 200 implements various functions by reading and performing various programs stored in the storage device (for example, the storage 210 or the ROM 220). The controller 200 may be implemented by, for example, one or multiple control devices/arithmetic devices (Central Processing Unit (CPU), System on a Chip (SoC)). The controller 200 may include one or multiple control circuits.

The storage 210 is a non-volatile storage device capable of storing programs and data. For example, the storage 210 may include one or multiple storage devices such as a Hard Disk Drive (HDD) or a Solid State Drive (SSD). The storage 210 may be an external device such as a USB memory that can be connected to the mobile terminal device 20. The storage 210 may be, for example, a storage area on a cloud.

The ROM 220 is a non-volatile memory capable of holding the program and data even in a case that the power is turned off.

The RAM 230 is a main memory mainly used in a case that the controller 200 of each device executes processing. The RAM 230 is a rewritable memory that temporarily holds a program read from the storage 210 or the ROM 220 and data including a result of the performance.

The display 240 is a display device capable of displaying various types of information such as system configuration information and content information. The display 240 may include, for example, a display device such as a Liquid Crystal Display (LCD), an Organic Electro Luminescence (EL) display, or an electrophoresis display. The display 240 may include an interface to which a display device can be connected. For example, the display 240 may include an external display device connected via a High-Definition Multimedia Interface (HDMI) (trade name), a Digital Visual Interface (DVI), or a Display Port.

The operation inputter 250 is an operation device that allows a user to input an operation. For example, the operation inputter 250 may be software keys displayed on a touch panel integrated with the display 240 or hardware keys such as operation buttons. The operation inputter 250 may be an operation device, for example, a keyboard or a mouse. The operation inputter 250 may also include an interface (for example, a Universal Serial Bus (USB)) to which an operation device can be connected. For example, the mobile terminal device 20 may be connected to different operation devices (a keyboard, a mouse, and the like) via an interface.

The imaging unit 260 scans an image and outputs the image as image data. The imaging unit 260 is, for example, a camera or the like, and may be an imaging device using a Charge Coupled Device (CCD) or a Complementary Metal-Oxide-Semiconductor (CMOS) image sensor. Note that, in the present embodiment, the mobile terminal device 20 includes the imaging unit 260 but that, for example, the mobile terminal device 20 may not include the imaging unit 260, and may instead connect to an external camera device or the like.

The communicator 270 is a communication interface that communicates with other devices. The communicator 270 may be, for example, a network interface capable of providing wired connection or wireless connection. The communicator 270 can directly communicate with the image forming device 10 via a short-range wireless communication protocol such as Wi-Fi (trade name), Bluetooth (trade name), infrared rays, NFC, or Radio frequency identification (RFID). In the present embodiment, communication with other devices is available via a network NW.

The configuration of the terminal device 30 is equivalent to that of a general computer, and thus a detailed description thereof will be omitted. For example, the terminal device 30 includes at least a controller, a storage (storage, ROM, RAM), and a communicator.

### 1.3 Software Configuration

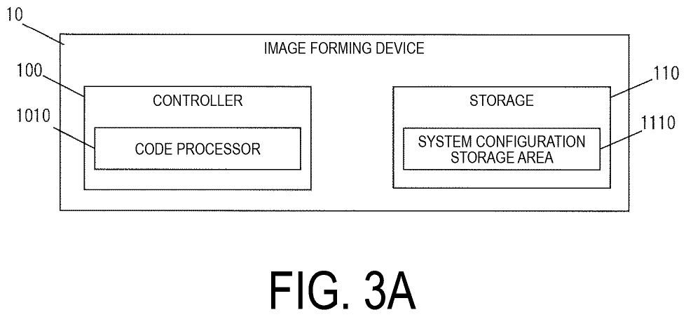

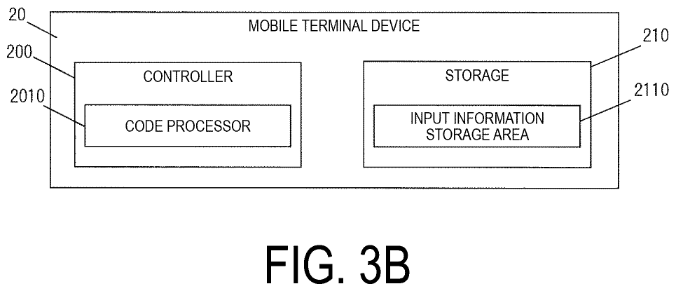

A configuration of main software in each device of the system 1 will be described with reference to FIGS. 3A and 3B. FIG. 3A is a diagram illustrating a software configuration of the image forming device 10, and FIG. 3B is a diagram for describing a main software configuration of the mobile terminal device 20. Note that, in the software configuration illustrated in FIGS. 3A and 3B, configurations necessary for the present embodiment are mainly described, and other configurations are omitted.

### 1.3.1 Image Forming Device 10

First, a software configuration of the image forming device 10 will be described. For example, the controller 100 can implement a code processor 1010 by reading and executing programs stored in the storage (for example, the storage 110 and the ROM 120).

The code processor 1010 acquires the second code information from the mobile terminal device 20. The code processor 1010 may acquire the second code information, for example, via the code information acquirer 180. Here, the code processor 1010 temporarily stores the second code information in the storage such as the storage 110. The code processor 1010 can perform processing of decoding the acquired second code information. Furthermore, the code processor 1010 performs processing of generating the first code information.

Note that, here, the code information refers to encoded information. The encoded information may be a graphic or a character string (here, the character string is a string of one or more characters. The characters may include one or more numbers, alphabets, kana, hiragana, kanji characters, symbols, or the like). When the encoded information is a graphic, the encoded information may be a one-dimensional code such as a barcode (for example, EAN code, JAN code, Codbar, CODE128, or the like) or may be a two-dimensional code. The two-dimensional code may be a stack type two-dimensional code (for example, PDF417, CODE49, or the like) or a matrix type two-dimensional code (for example, a quick response code (QR code (trade name)), DataMatrix, VeriCode, or Aztec). In the present embodiment, a quick response code (QR code (trade name)) will be described as an example.

In addition to the above-described method, the code processor 1010 may use a method of decoding and encoding code information used in the related art.

The storage 110 secures a system configuration storage area 1110 for storing system configuration information. In the image forming device 10, the system configuration refers to a configuration necessary for an operation of the image forming device 10 or a configuration necessary for processing executed by the image forming device 10. When a user, an administrator, or the like configures a configuration value for each configuration item in the system configuration, the controller 100 stores the configuration value in the system configuration storage area 1110 as system configuration information.

Here, the “configuration items” of the system configuration information include “necessary configurations”. Here, the “necessary configurations” are, for example, the bare minimum items that is required to be configured in the initial configuration. Examples of the “necessary configuration” include configuration items such as an administrator password configuration, a language configuration, and a network configuration. The “configuration items” include configuration items other than the “necessary configurations”. The configuration items other than the necessary configurations include, for example, firmware version information (update status) and configuration items unique to functions implemented by the image forming device 10. Specific examples of the configuration items unique to the functions of the image forming device 10 include a print configuration, a power saving configuration, and a configuration for accepting printing from the terminal device 30. Here, among the configuration items of the image forming device 10, the configurations other than the necessary configurations are hereinafter referred to as “function configurations”.

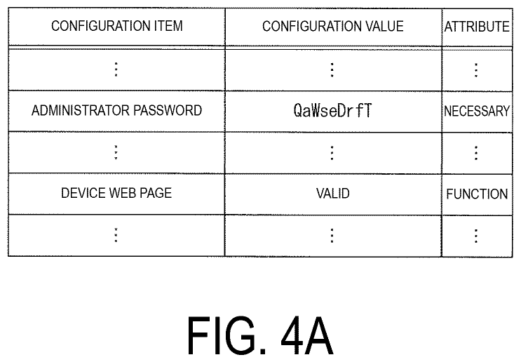

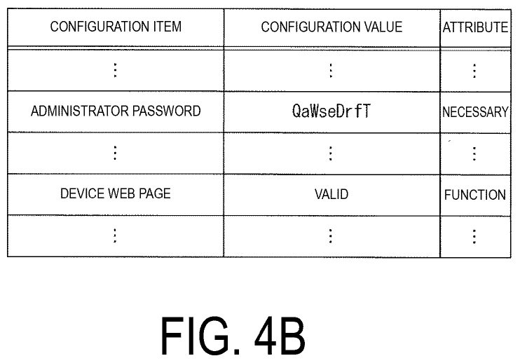

Here, an example of the system configuration information stored in the system configuration storage area 1110 will be described with reference to FIG. 4A. The stored system configuration information includes a configuration item (for example, “administrator password”) of the image forming device 10, an arbitrarily input or selected configuration value (for example, “QaWseDrfT”), and a selected attribute (for example, “necessary”). Here, the attribute is information including “necessary” indicating that the configuration item is a “necessary configuration” or “function” indicating a “function configuration”. The attribute may be determined in advance or may be configured by an administrator later.

### 1.3.2 Mobile Terminal Device 20

Now, a main software configuration of the mobile terminal device 20 will be described. The controller 200 implements a code processor 2010 by reading and executing programs stored in the storage (for example, the storage 210 or the ROM 220).

The code processor 2010 acquires the first code information. Here, the code processor 2010 temporarily stores the first code information in the storage such as the storage 210, for example. The code processor 2010 can perform processing of decoding the acquired first code information. Further, the code processor 2010 performs processing of generating the second code information.

The code processor 2010 may acquire the first code information by using, for example, a camera provided in the imaging unit 260 or the like. Alternatively, processing of acquiring the first code information may be performed by inputting a character string from the operation inputter 250 or the like.

The code processor 2010 may be implemented by an application. For example, the first code information (two dimensional code) included in an image captured by the camera may be read and decoded. A code information scanning function may be used that is provided by a camera function of the mobile terminal device 20.

The storage 210 secures an input information storage area 2110 that stores input information that is information related to an initial configuration of the image forming device 10.

Here, an example of the input information stored in the input information storage area 2110 will be described with reference to FIG. 4B. The input information is information including a configuration value associated with information stored in the system configuration storage area 1110 of the image forming device 10. In FIG. 4B, the stored input information includes a configuration item (for example, a “device Web page”), a configuration value (for example, “valid”), and an attribute (for example, “function”). Note that the input information storage area 2110 may include at least configuration values, and may store configuration items and the attribute as necessary.

### 1.4 Processing Flow

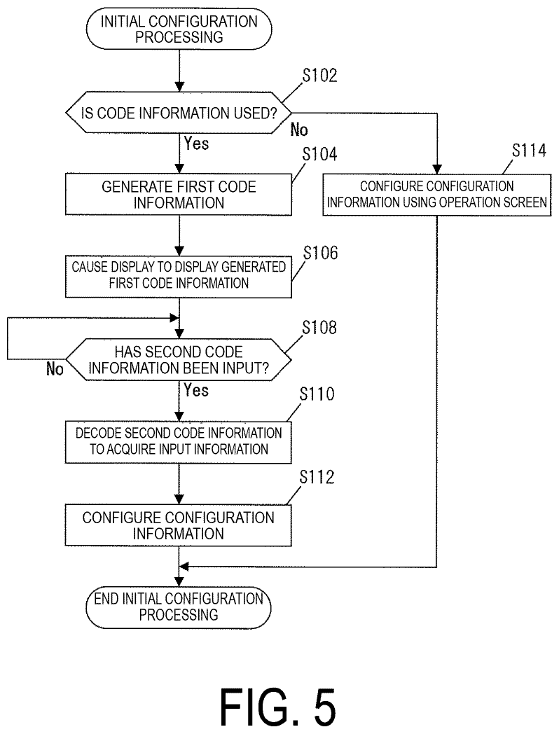

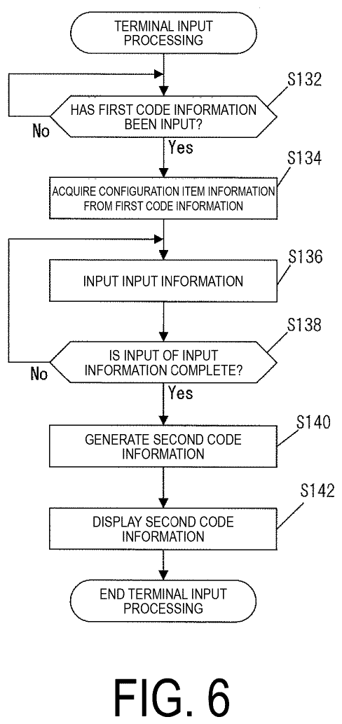

Hereinafter, a processing flow according to the present embodiment will be described with reference to FIGS. 5 and 6. Although the initial configuration is performed in the present embodiment, the disclosure can be applied to configuration processing other than the initial configuration, for example, configuration processing executed in a case where a network is not available.

### 1.4.1 Initial Configuration Processing

FIG. 5 is a diagram illustrating a flow of initial configuration processing according to the present embodiment. Note that the configuration described with reference to FIG. 2 or 3 may execute the processing of each step.

First, the controller 100 determines whether to use the code information (S102). Here, using the code information means, for example, passing (transmitting and receiving) information regarding the initial configuration between the image forming device 10 and the mobile terminal device 20 using the code information.

For example, as a method of determining whether to use the code information, the controller 100 may determine whether to use the code information based on a user operation of selecting whether to use the code information. The administrator may perform a configuration in advance or configure a security policy to allow the controller 100 to determine whether to use the code information according to the configuration.

Subsequently, in a case of using the code information, the controller 100 generates the first code information (S102; Yes→S104). The controller 100 extracts information for generating the first code information and generates the first code information based on the extracted information. Specifically, the controller 100 extracts the following information.

(1) Information related to configuration items: Information related to configuration items to be input as input information among the configuration items stored in the system configuration storage area 1110 illustrated in FIG. 4A. Note that the controller 100 may include current configuration values together with the configuration items. The controller 100 may include the attribute in order for the mobile terminal device 20 to determine whether the configuration item is a “necessary configuration” or a “function configuration”.

(2) Information related to the device: Information related to the image forming device 10 and including, for example, a model number, a series name, a firmware version, a device configuration, and the like of the image forming device 10. In this case, the mobile terminal device 20 may acquire the information related to the configuration items via an application or a network based on the information related to the device.

(3) Information related to connection: For example, information for connecting (handshaking) the image forming device 10 and the mobile terminal device 20, and specifically, information such as a passcode for connecting the image forming device 10 and the mobile terminal device 20. The connection information may include information such as a one-time password.

Note that when generating the first code information, the controller 100 may include related information as a configuration value of the first code information. The controller 100 may include, for example, related information such as a character type, the number of characters, and a prohibition rule related to the configuration value. The related information may be included in the attribute.

The controller 100 displays the generated first code information on the display 140 (S106). The controller 100 displays an image (for example, two dimensional codes or the like) or character strings corresponding to the first code information. At this time, the controller 100 may display multiple types of first code information, for example, a character string displayed together with a two dimensional code. Alternatively, the controller 100 may perform processing of prompting the user to select the type of the first code information to be displayed.

On the other hand, in a case of using no code information, the controller 100 configures the configuration information using the operation screen of the image forming device 10 (S102; No→S114). Here, the controller 100 causes the display 140 to display, for example, a configuration screen including configuration items and configuration values of necessary configurations and function configurations, and stores the configuration values in the system configuration storage area 1110 when the user inputs the configuration values.

Next, the controller 100 determines whether the second code information has been input (S108). Here, the second code information is input, for example, by the controller 100 using the code information acquirer 180 to input the second code information such as a two dimensional code displayed on the display 240 of the mobile terminal device 20. In a case where the second code information has been input, the controller 100 may decode the input second code information to acquire the decoded information as input information (S108; Yes→S110).

Further, for example, the controller 100 may perform, for example, processing of temporarily storing, in the storage such as the storage 110, the input information acquired by decoding the second code information. Here, the input information may be, for example, only the information of configuration items and configuration values related to the “necessary configuration”, or may further include configuration items and configuration values related to the “function configuration”. The input information may include information for a handshake with the mobile terminal device 20, specifically, information such as a passcode for connecting the image forming device 10 and the mobile terminal device 20.

On the other hand, in a case where no second code information has been input, the controller 100 repeats again the determination of whether the second code information has been input (S108; No→S108).

Subsequently, the controller 100 configures system configuration information (S112). Here, for example, based on the acquired input information, the controller 100 stores the configuration values corresponding to the configuration items of the input information in the configuration values corresponding to the configuration items in the system configuration storage area 1110. Based on the configuration items and the configuration values included in the input information, the controller 100 stores, in the system configuration storage area 1110, the configuration values of the configuration items of the corresponding system configuration information and ends the initial configuration processing.

Note that the input information may include at least configuration values. For example, when the configuration value is assigned with a configuration value corresponding to the configuration item included in the input information, the configuration value having a fixed length, the controller 100 stores the configuration value of the configuration item based on the configuration value included in the input information.

### 1.4.2 Terminal Configuration Processing

FIG. 6 is a diagram illustrating a flow in the initial configuration processing of the present embodiment. Although the following processing will be described as being executed by the controller 200 of the mobile terminal device 20, the configuration described in FIG. 2 or 3 may execute the processing of each step.

First, the controller 200 determines whether the first code information has been input (S132). Here, the mobile terminal device 20 may determine that the first code information has been input, for example, when the imaging unit 260 scans the first code information displayed on the display 140 of the image forming device 10.

Then, in a case where the first code information has been input, the controller 200 acquires the configuration item information from the first code information (S132; Yes→S134). Here, acquiring, by the controller 200, the configuration item information means, for example, decoding the first code information to acquire the configuration item information included in the information necessary for configuration of the image forming device 10. The configuration item information may be, for example, information including at least “configuration items” and further including the “attribute”. Here, based on the acquired configuration item information, the controller 200 stores information necessary for configuration of the image forming device 10 in the input information storage area 2110 of the mobile terminal device 20.

At this time, among the pieces of information obtained by decoding the first code information, the controller 200 may temporarily store the information other than the configuration item information in the storage 210. As the information other than the configuration items, the controller 200 may store information such as the model number, series name, firmware version information, and connection information (for example, a one-time password) of the image forming device 10.

Subsequently, the controller 200 inputs input information (S136). Here, for example, based on the configuration item information of the image forming device 10, the controller 200 displays a configuration screen on the display 240 to prompt the user to input configuration values. Specifically, the displayed configuration screen includes configuration items and configuration values based on the configuration items stored in the input information storage area 2110. Then, for example, the controller 200 stores the configuration values input by the user in the configuration values of the input information storage area 2110.

Then, the controller 200 determines whether input information has been input (S138). Here, the controller 200 may determine that input of the input information is complete in a case where all the configuration values of the configuration items stored in the input information storage area 2110 have been input. Note that the controller 200 may determine that input of the input information is complete when, among the configuration items of the input information, only some configuration items (necessary configurations) have been input.

In a case of determining that input of the input information is complete, the controller 200 generates the second code information (S138; Yes→S140). The controller 200 may generate two dimensional codes or character strings based on the input information, for example, the configuration values stored in the input information storage area 2110. In addition to the configuration values, the controller 200 may include configuration items or the attribute in the second code information. The second code information generated by the controller 200 may include, for example, information for a handshake with the image forming device 10 side, specifically, information such as a passcode.

Then, the controller 200 displays the second code information (S142). For example, the controller 200 may display the second code information on the display 240. At this time, the controller 200 may display multiple types of second code information, for example, a character string displayed together with a two dimensional code. Alternatively, the controller 200 may perform processing of prompting the user to select the type of the second code information to be displayed.

On the other hand, in a case of determining that the input of the configuration information is not complete, the controller 200 continues to input the input information (S138; No→S136).

### 1.5 Operation Examples

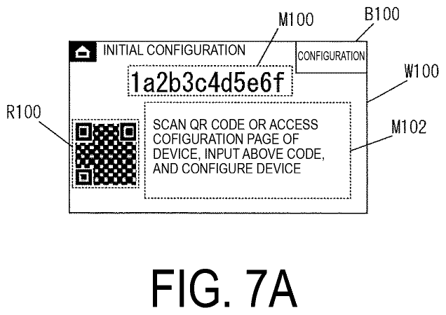

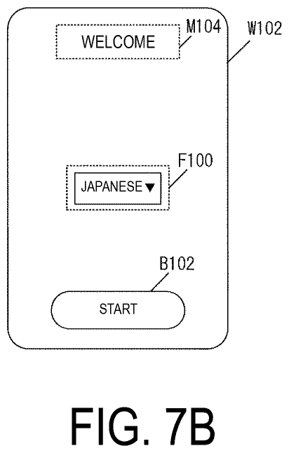

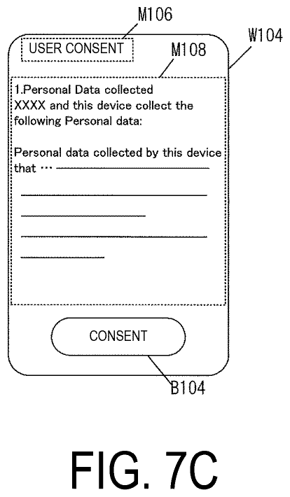

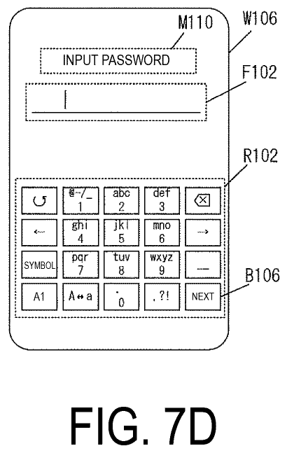

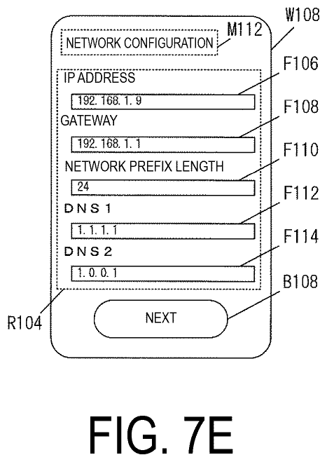

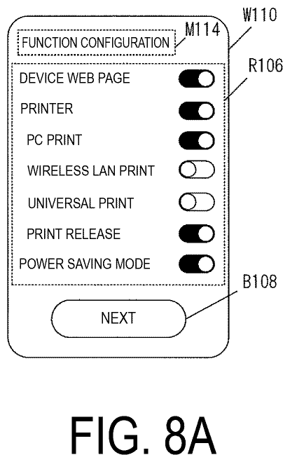

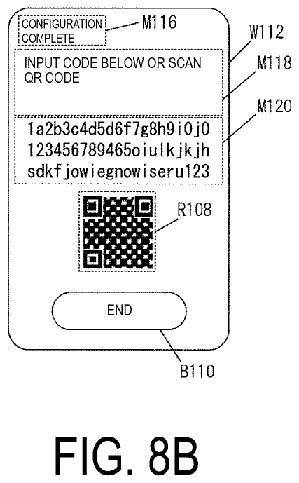

FIGS. 7 and 8 are diagrams illustrating examples of display screens including messages displayed to the user as results of operations of the image forming device 10 and the mobile terminal device 20 according to the present embodiment.

FIG. 7A is a diagram illustrating an example of a display screen W100 displayed on the display 140 of the image forming device 10. The display screen W100 is a diagram illustrating an example of a display screen including a message displayed to the user in a case where the controller 100 performs an initial configuration without involving a network or the like, for example, at the time of initial activation of the MFP in a factory shipment state (network unconnected state) or based on selection by the user.

In an area R100 of the display screen W100, a two dimensional code (QR code) is displayed as the first code information. Further, the display screen W100 displays a message M100 which is a character string represented by a different type of first code information. In FIG. 7A, multiple types (two types) of first code information are displayed. However, only one of the two types of first code information may be displayed, or more types of first code information may be displayed.

The display screen W100 may display a message M102 describing an operation for the user and a configuration button B100. At this time, when the user selects the configuration button B100, the display screen W100 transitions to display, for example, a configuration screen in which the configuration information is configured using the operation screen.

FIG. 7B is a diagram illustrating an example of a display screen W102 displayed on the display 240 by scanning, in the mobile terminal device 20, the QR code displayed in the area R100 of the display screen W100 illustrated in FIG. 7A. For example, FIG. 7B is a diagram illustrating an example of a message displayed to the user by the display 240 of the mobile terminal device 20 in a case where the mobile terminal device 20 scans the QR code using an application or the like stored in the storage 210. The display screen W102 displays a message M104 for the user, a change form F100 for changing the language configuration of the image forming device 10 as necessary, and a start button B102. When the user selects the start button B102, the controller 100 transitions the display screen W102 to display a display screen W104 of FIG. 7B.

When the user selects the start button B102 in FIG. 7B, the display screen W104 may be displayed as illustrated in FIG. 7C; the display screen W104 is an example of a display screen including a message to be displayed to the user. The display screen W104 displays a message M106 describing the gist of display contents of the display screen W104, a user's consent form message M108, and a consent button B104. When the user selects the consent button B104, the controller 100 transitions the display screen W104 to display a display screen W106 of FIG. 7D.

FIG. 7D is a diagram illustrating an example of the display screen W106 including a message to be displayed to the user in a case where the user selects the consent button B104 in FIG. 7C. The display screen W106 displays a message M110 requesting the user to input a password, a password input form F102, and a keyboard area R102 into which a password is input. Further, a next button B106 is displayed in the keyboard area R102. Here, when the user selects the next button B106, the controller 100 transitions the display screen W106 to display a display screen W108 of FIG. 7E. Note that the user can input a password into the input form F102, but that when information related to the first code information is included, the input form SL can be limited to, for example, the character type and the number of characters restricted by the related information.

FIG. 7E is a diagram illustrating an example of the display screen W108 including a message displayed to the user in a case where the user selects the next button B106 in FIG. 7D. The display screen W108 displays a message M112 requesting the user to input network configurations to the form, a network configuration input area R104, and a next button B108. Further, the network configuration input area R104 displays an IP-address input form F106, a gateway input form F108, a network-prefix-length input form F110, a DNS1 input form F112, and a DNS2 input form F114.

In this way, configurations necessary for the image forming device 10 can be input in the mobile terminal device 20. That is, although the image forming device 10 is not connected to the network, the user can input configurations of the network via the mobile terminal device 20 as necessary configurations.

Here, when the user selects the next button B108, the controller 100 transitions the display screen W108 to display a display screen W110 of FIG. 8A.

FIG. 8A is a diagram illustrating an example of the display screen W110 including a message displayed to the user in a case where the user selects the next button B108 in FIG. 7E. The display screen W110 displays a message M114 requesting the user to provide function configurations, a function configuration input area R106, and the next button B108. Further, the network configuration input area R106 displays buttons (toggle switches) for switching on/off (enabling/disabling) a device web page, a printer, PC print, wireless LAN print, universal print, print release, and a power saving mode. Here, when the user selects the next button B108, the controller 100 transitions the display screen W108 to display a display screen W112 of FIG. 8B.

In this way, the user can input and configure not only necessary configurations but also function configurations. As a result, the user does not need to configure the configuration values related to the function configurations again in the image forming device 10 after the initial configuration, and can collectively configure the configuration values on the initial screen.

FIG. 8B is a diagram illustrating an example of the display screen W112 including a message displayed to the user in a case where the user selects the next button B108 in FIG. 8A. The display screen W112 displays a configuration complete message M116 and a message M118 indicating a character code and an operation for the user. The display screen W112 displays a QR code, which is a two dimensional code, in the area R108 as the second code information. In FIG. 8B, a character string that is different type of second code information is displayed in the message M120 as the second code information. Note that at least one type of second code information may be displayed.

Further, an end button B110 is displayed on the display screen W112. When the user selects the end button B110, the controller 100 closes the display screen W112 to complete the initial configuration.

As described above, the user can provide necessary configurations in the image forming device 10 without using the network. Even in a case where provision of necessary configurations via the network is restricted, for example, even in a case where the network configuration is not complete, the law prohibits the necessary configurations from being provided via the network, or any problem or the like prevents the use of the network, the necessary configurations can be provided by causing the image forming device 10 to scan the second code information generated from the input information configured via the mobile terminal device 20 or the terminal device 30.

### 1.6 Effects and the Like

As described above, according to the present embodiment, even in a case where the network connection of the image forming device 10 is restricted, the controller 100 can easily configure the information processing apparatus using, for example, the two dimensional code or the like.

For example, in the initial installation configuration, in a case where scanning many characters or a complicated operation is difficult when the information processing apparatus includes a small display screen or operation screen, or even in a state where configuration via the network is disabled, the configuration can be easily performed. That is, usability is improved.

### 2. Second Embodiment

Hereinafter, a second embodiment will be described. The second embodiment allows the user to select from multiple configuration methods (means) for the initial configuration.

For the second embodiment, the same hardware and software configurations between the first embodiment and the second embodiment will not be described, and differences from the first embodiment will be focused on.

### 2.1 Processing Flow

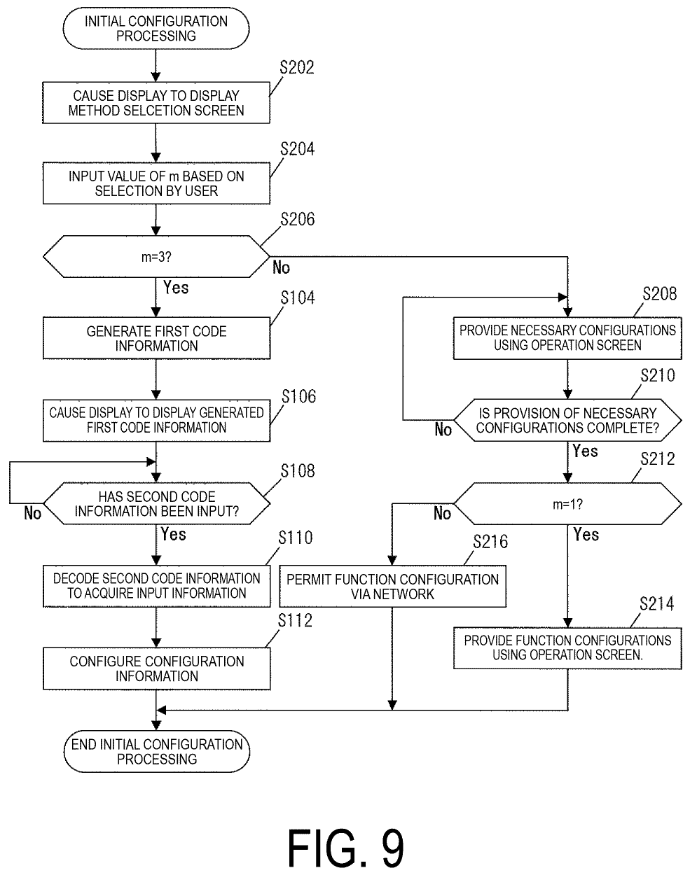

FIG. 9 is a diagram for describing a flow of processing according to the present embodiment. FIG. 9 substitutes for FIG. 5 for the first embodiment. S202, S204, and S206 are executed before S104 in FIG. 5.

First, the controller 100 displays a method selection screen on the display 140 (step S202). Here, the method selection screen is, for example, a display screen on which a configuration method can be selected. Specifically, the method selection screen may be a display screen displaying a configuration method to the user as a message and including buttons or the like for selection.

Here, the configuration method is, for example, a method of configuring system configuration information. Specifically, the configuration method refers to configuring the system configuration information using the display 140 and the operation inputter 150; connecting to the image forming device 10 from the mobile terminal device 20 or the terminal device 30 via the network and configuring the system configuration information using a web browser or the like; scanning the second code information such as a two dimensional code or a character string to acquire input information and configuring the system configuration information; or the like. The configuration method may be selected from multiple configuration methods by operation of the user, for example.

Then, the controller 100 inputs the value of m based on the selection of the user (S204). In the present embodiment, the value of m is, for example, equal to or greater than 1 and is used to identify the configuration method selected by the user. Specifically, the controller 100 may input m=1 in a case where the user selects a first configuration method, may input m=2 when the user selects a second configuration method, and may input m=3 when the user selects a third configuration method. Here, the value of m is determined in accordance with a prepared configuration method, and in a case where the number of configuration methods prepared in advance is three, m may be selected from numbers of 1, 2, and 3. The controller 100 temporarily stores the value of m in the storage 110, for example.

Note that although, in the present embodiment, the value of m indicates the configuration method selected by the user, another method may be used. For example, the controller 100 may cause the display 140 to display description of the configuration methods and description of the corresponding operation buttons provided on the operation inputter 150, associate the displayed configuration methods with the operation buttons or the like provided on the operation inputter 150 and corresponding to the configuration methods, determine that the user has selected a configuration method based on the user operating the corresponding operation button or the like, and temporarily store the selected configuration method in the storage 110.

Then, the controller 100 determines whether m=3 (S206). For example, the controller 100 makes the determination based on the value of m stored in the storage 110. Here, in a case where m=3, the controller 100 generates the first code information (S206; Yes→S104).

On the other hand, in a case where m is not 3, the controller 100 provides necessary configurations using the operation screen of the image forming device 10 (S206; No→S208). Here, for example, the controller 100 displays a configuration screen including configuration items and configuration values based on the attribute (for example, “necessary”) related to the necessary configurations stored in the system configuration storage area 1110, prompts the user to input the configuration values, and stores the input configuration values in the system configuration storage area 1110.

Subsequently, the controller 100 determines whether provision of the necessary configurations is complete (S210). Here, as a method of determining whether provision of the necessary configurations is complete, for example, the controller 100 may determine that provision of the necessary configurations is complete in a case where all the configuration values corresponding to the configuration items of the necessary configurations have been input based on the attribute (for example, “necessary”) related to the necessary configurations stored in the system configuration storage area 1110. Here, in a case of determining that provision of the necessary configurations is not complete, the controller 100 repeats providing the necessary configuration using the operation screen of the image forming device 10 (S210; No→S208).

On the other hand, in a case of determining that provision of the necessary configurations is complete, the controller 100 determines whether m=1 (S210; Yes→S212). For example, the controller 100 makes the determination based on the value of m stored in the storage 110. Here, in a case of determining that m=1, the controller 100 provides the function configurations using the operation screen (S212; Yes→S214). Here, for example, for example, the controller 100 displays a configuration screen including configuration items and configuration values based on the attribute (for example, “function”) related to the necessary configurations stored in the system configuration storage area 1110, prompts the user to input configuration values, and stores the input configuration values in the system configuration storage area 1110.

On the other hand, in a case determining that m is not 1, the controller 100 permits the function configurations to be provided via the network (S212; No→S216). Here, for example, the controller 100 enables the network connection based on the necessary configurations stored in the system configuration storage area 1110 and permits the network connection from the mobile terminal device 20, the terminal device 30, or the like. Then, the controller 100 displays a configuration screen on the web browser or the like of the mobile terminal device 20 or the terminal device 30 via the network, prompts the user to input the configuration values of the function configurations stored in the system configuration storage area 1110, and stores the input configuration values in the system configuration storage area 1110.

### 2.2 Operation Example

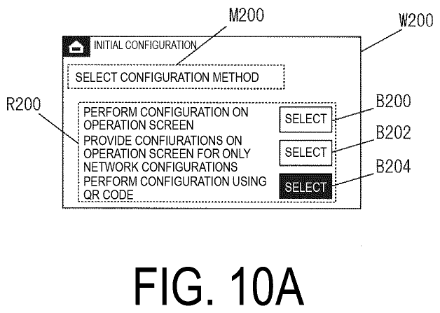

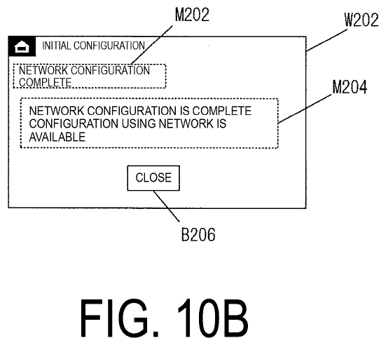

FIGS. 10A and 10B are diagrams illustrating an example of a display screen including a message displayed to the user as a result of operation of the image forming device 10 according to the present embodiment.

FIG. 10A is a diagram illustrating an example of a display screen W200 displayed on the display 140 of the image forming device 10. The display screen W200 is a diagram illustrating an example of a display screen including a message displayed to the user in a case where the controller 100 performs the initial configuration without involving the network or the like, for example, at the time of initial activation of the MFP in the factory shipment state or based on the selection by the user.

The area R200 of the display screen W200 displays, as a method of initial configuration, description of a first configuration method including configuration on the operation screen (of the image forming device 10), a select button B200 corresponding to the first configuration method, description of a second configuration method including configuration on the operation screen (of the image forming device 10) only for the network configuration, a select button B202 corresponding to the second configuration method, description of a third configuration method including configuration with a QR code, and a select button B204 corresponding to the third configuration method. Further, the display screen W200 displays a message M200 prompting the user to select a configuration method.

At this time, for example, when the user selects the select button B200 or the select button B202, the controller 100 transitions the display screen W200 to display a configuration screen related to necessary configurations. Note that, in a case where the user selects the select button B202 and the controller 100 determines that provision of the necessary configurations is complete, the controller 100 displays a display screen W202 of FIG. 10B. When the user selects the identifiably displayed select button B204, the controller 100 transitions the display screen W200 to display, for example, the display screen W100 of FIG. 7A.

FIG. 10B is a diagram illustrating an example of a display screen W202 displayed in a case where the user selects the select button B202 on the display screen W200 illustrated in FIG. 10A. For example, FIG. 10B is a diagram illustrating an example of a message displayed to the user when the controller 100 determines that provision of the necessary configurations is complete. The display screen W202 displays a message M202 indicating that the network configuration is complete, a message M204 indicating that connection via the network has been enabled, and a close button B206. When the user selects the close button B206, the controller 100 directly closes the display screen W202 without any change. Accordingly, the user can connect to the image forming device 10 via the network, and thus, for example, configure the remaining system configuration information from the mobile terminal device 20 or the terminal device 30 via the network.

### 2.3 Effects and the Like

As described above, according to the present embodiment, the user can select an optimum configuration method from multiple configuration methods in the initial configuration according to the convenience of the user. For example, in a case where the network cannot be used at the start of the initial configuration, bare minimum configuration is performed to make connection from the network. Alternatively, flexible configuration can be performed depending on whether the user carries the mobile terminal device 20 and the like, improving usability.

### 3. Third Embodiment

Hereinafter, a third embodiment will be described. In the third embodiment, one of multiple configuration methods can be selected as in the second embodiment, and the configuration method can be freely changed in the middle of the initial configuration depending on the convenience of the user.

For the third embodiment, the same hardware and software configurations between the third embodiment and both the first embodiment and the second embodiment will not be described, and differences from the first embodiment and the second embodiment will be focused on.

### 3.1 Processing Flow

### 3.1.1 Initial Configuration Processing

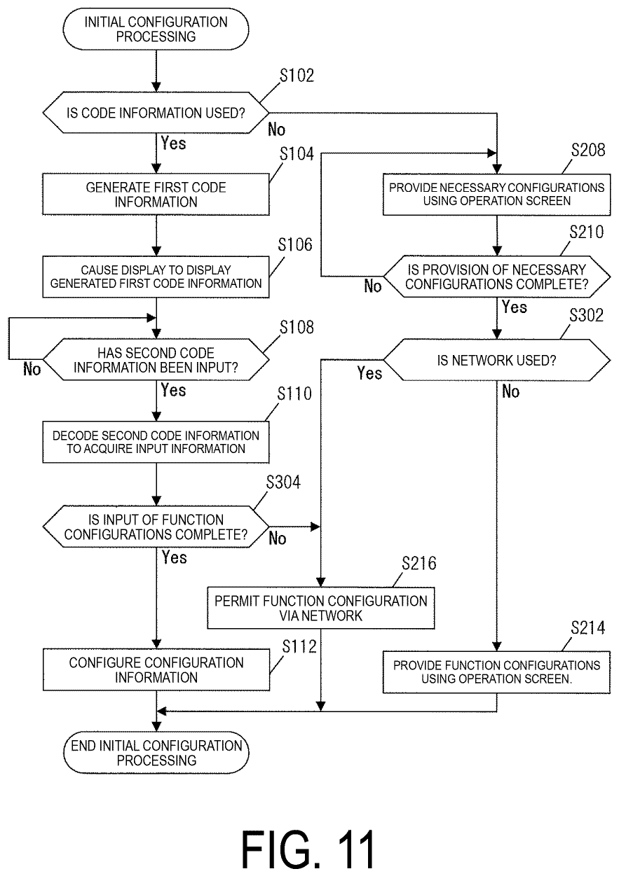

FIG. 11 is a diagram for describing a flow of processing according to the present embodiment.

FIG. 11 substitutes for FIG. 5 for the first embodiment. S208 is executed after S102 in FIG. 5, S302 is executed between S210 and both S214 and S216, and S112 is executed between S110 and S304.

Upon determining that provision of the necessary configurations is complete, the controller 100 determines whether to use the network (S210; Yes→S302). Here, as a method of determining whether to use the network, for example, the controller 100 may display, to the user, a display screen including a message indicating whether to use the network and a select button, and determine that the user has used the network in a case where the user selects to use the network. In a case where the user selects configuration by the network, the controller 100 provides the function configurations via the network (S302; Yes→S216). On the other hand, in a case of determining that the network is not to be used, the controller 100 provides the function configurations using the operation screen (S302; No→S214).

The controller 100 determines whether input of the function configurations is complete (S304). Here, as a method of determining whether input of the function configurations is complete, for example, in a case where all the configuration values have been input for the configuration items associated with the attribute (for example, “function”) related to the function configurations of the input information stored in the storage 110, the controller 100 may determine that the function configurations have been input into the acquired input information.

Upon determining that input of the function configurations is complete, the controller 100 configures the system configuration information (S304; Yes→S112). On the other hand, upon determining that input of the function configurations is not complete, the controller 100 permits the function configurations to be provided via the network (S304; No→S216). Note that, in the present embodiment, in a case where the configuration values of the function configurations have not been input, the function configurations are provided via the network. However, for example, predetermined default values stored in the ROM 120 or the storage 110 may be provided as the configuration values of the function configurations.

Note that the above-described operation flow is an example, and partially different processing may be performed. For example, the order of the flow may be changed to perform processing such as S304; No→S302. Alternatively, new processing of returning to S102 based on selection by the user may be added between S208 and S210. In this way, the configuration method can be freely changed based on the selection by the user.

### 3.1.2 Terminal Input Processing

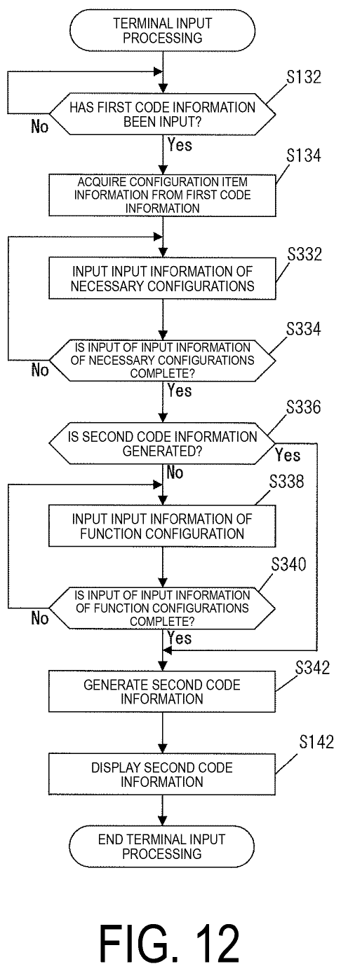

FIG. 12 is a diagram for describing a flow of processing according to the present embodiment. FIG. 12 substitutes for FIG. 6 for the first embodiment. S332, S334, S336, S338, S340, and S342 are executed between S134 and S142 in FIG. 6.

The controller 200 of the mobile terminal device 20 inputs input information of the necessary configurations (S332). Here, for example, based on the configuration item information, the controller 200 causes the display 240 to display a configuration screen including configuration items belonging to the necessary configurations stored in the input information storage area 2110 (for example, the configuration items whose attribute is stored as “necessary”) and configuration values to prompt the user to input the configuration values, and stores the configuration values input by the user in the configuration values of the input information storage area 2110.

Subsequently, the controller 200 determines whether input of the input information of the necessary configurations is complete (S334). Here, for example, in a case where all the configuration values of the configuration items belonging to the necessary configurations stored in the input information storage area 2110 have been input, the controller 200 may determine that input of the input information of the necessary configurations is complete. Here, in a case of determining that input of the input information of the necessary configurations is not complete, the controller 200 repeats inputting the input information of the necessary configuration until the controller determines that input of the input information of the necessary configurations is complete (S334; No→S332).

On the other hand, in a case where of determining that input of the input information of the necessary configurations is complete, the controller 200 determines whether to generate the second code information (S334; Yes→S336). Here, as a method of determining whether to generate the second code information, for example, the controller 200 may cause the display 240 to display a display screen including a message indicating that provision of the necessary configurations is complete and a select key for determining whether to generate the second code information, and may determine to generate the second code information in a case where the user selects to generate the second code information.

Here, upon determining to generate the second code information, for example, the controller 200 generates the second code information based on the configuration items and the configuration values belonging to the necessary configurations stored in the input information storage area 2110. (S336; Yes→S342)

On the other hand, in a case of determining not to generate the second code information, the controller 200 inputs the input information of the function configurations (S336; No→S338). Here, for example, based on the configuration item information, the controller 200 causes the display 240 to display a configuration screen including configuration items belonging to the function configurations stored in the input information storage area 2110 (for example, the configuration items whose attribute is stored as “function”) and configuration values, prompts the user to input the configuration values, and stores the configuration values input by the user in the configuration values of the input information storage area 2110.

Subsequently, the controller 200 determines whether input of the input information of the function configuration is complete (S340). Here, for example, in a case where all the configuration values have been input for the configuration items belonging to the function configurations stored in the input information storage area 2110, the controller 200 may determine that input of the input information of the function configurations is complete. Here, in a case of determining that input of the input information of the function configurations is not complete, the controller 200 repeats inputting the input information of the function configuration until the controller 200 determines that input of the input information of the function configurations is complete (S340; No→S338).

On the other hand, upon determining that input of the input information of the function configurations is complete, for example, the controller 200 generates the second code information based on the configuration items and the configuration values stored in the input information storage area 2110. (S340; Yes→S342)

### 3.2 Operation Examples

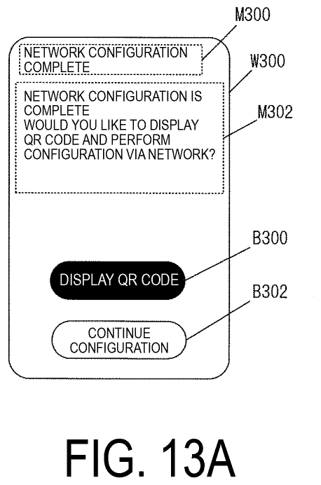

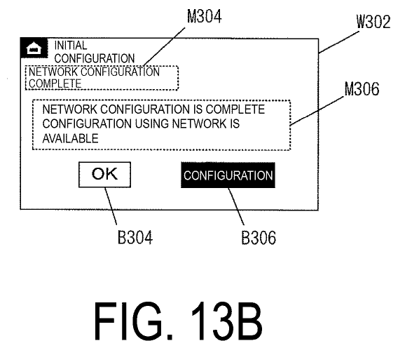

FIG. 13A is a diagram illustrating an example of a display screen W300 displayed on the display 240 of the mobile terminal device 20. The display screen W300 is a diagram illustrating an example of a screen including a message displayed to the user in a case where the controller 200 determines that input of the necessary configurations is complete, for example. The display screen W300 displays a message M300 indicating that the network configuration is complete. Further, the display screen W300 displays a message M302 for checking whether to generate the second code information, a QR code display button B300, and a configuration continue button B302. At this time, when the user selects the QR code display button B300, the controller 200 transitions the display screen W300 to display, for example, the display screen W112 of FIG. 8B. When the user selects the configuration continue button B302, the controller 200 transitions the display screen W300 to display, for example, the display screen W110 of FIG. 8A.

FIG. 13B is a diagram illustrating an example of the display screen W302 displayed in a case where the user selects the configuration button B100 illustrated in FIG. 7A and provides the necessary configurations using the operation screen. For example, FIG. 13B is a diagram illustrating an example of a message displayed to the user when the controller 100 determines that input of the input information of the necessary configurations is complete. The display screen W302 displays a message M304 indicating that the network configuration is complete, a message M306 indicating that configuration via the network has been enabled, an OK button B304, and an identifiably displayed configuration button B306. When the user selects the OK button B304, the controller 100 directly closes the display screen W302 without any change. When the user selects the identifiably displayed configuration button B306, the display screen W302 transitions to display, for example, a configuration screen in which the function configurations are provided using the operation screen. Accordingly, the user can connect to the image forming device 10 via the network, and thus, for example, configure the remaining system configuration information from the mobile terminal device 20 or the terminal device 30 via the network.

### 3.3 Effects and the Like

For example, even in a case where the user actually performs the configuration method selected by the user and feels that the configuration method is hard to use, the user can freely switch the configuration method in the middle of the initial configuration. A part or all of the initial configuration can be switched to a preferred configuration method. That is, the demand of the user can be flexibly satisfied, thus improving usability.

### 4. Fourth Embodiment

Hereinafter, a fourth embodiment will be described. In the fourth embodiment, among the configuration items related to the necessary configurations, only the administrator password, for example, is configured on the operation screen and the remaining system configuration information is configured using, for example, the second code information. The fourth embodiment includes determining whether a passcode is included that connects the image forming device 10 and the mobile terminal device 20, and executing processing of configuring the system configuration information when the passcode is included.

For the fourth embodiment, the same hardware and software configurations between the first embodiment and the fourth embodiment will not be described, and differences from the first embodiment will be focused on.

### 4.1 Processing Flow

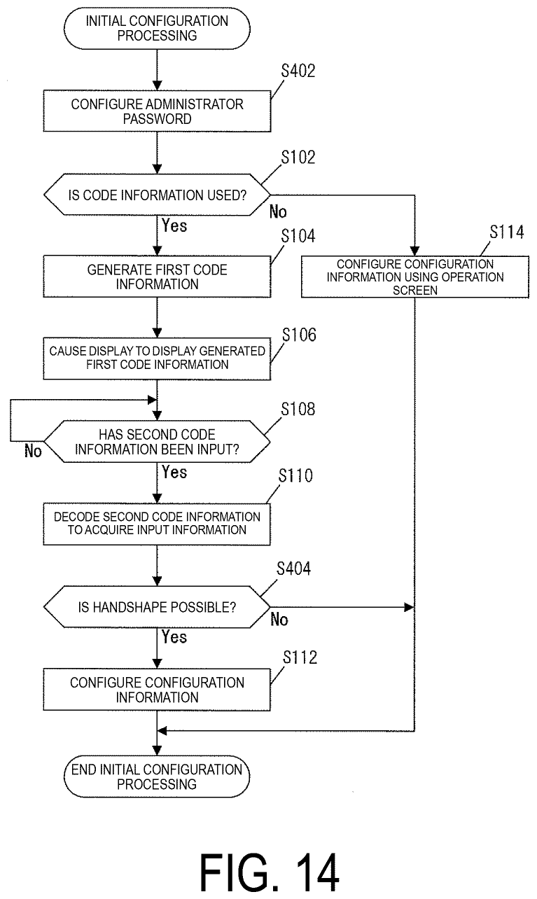

FIG. 14 is a diagram for describing a flow of processing according to the present embodiment. FIG. 14 substitutes for FIG. 5 for the first embodiment. S402 is executed before S102 in FIGS. 5, and S404 is executed between S110 and S112.

The controller 100 configures the administrator password (S402). Here, configuration of the administrator password refers to, for example, the controller 100 causing the display 140 to display a configuration screen including a configuration value corresponding to the configuration item of the administrator password stored in the system configuration storage area 1110, and when the user inputs the configuration value, causing the configuration value to be stored in the system configuration storage area 1110. Note that, in the present embodiment, the administrator password is configured as an example. However, for example, among the necessary configurations such as the user consent form and the language configuration, configuration items that are preferably configured in the image forming device 10 may be configured using the operation screen.

Here, the controller 100 determines whether a handshake is possible (S404). For example, based on the connection information included in the acquired input information, the controller 100 determines whether the image forming device 10 and the mobile terminal device 20 can be connected (handshake). Here, as a method of determining whether a handshake is possible, for example, a handshake is determined to be possible in a case where information such as a passcode connecting the image forming device 10 and the mobile terminal device 20 matches information such as a passcode included in the first code information.

Upon determining that a handshake is possible, the controller 100 configures the system configuration information (S404; Yes→S112). On the other hand, upon determining that no handshake is possible, the controller 100 provides the function configurations via the network (S404; No→end of initial configuration processing).

Note that the above-described operation flow is an example, and partially different processing may be performed. For example, the processing of S402 may be removed and executed between the processing of S110 and the processing of S112.

### 4.2 Operation Example

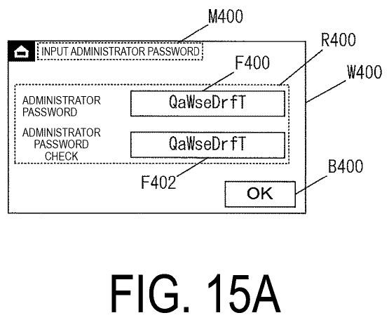

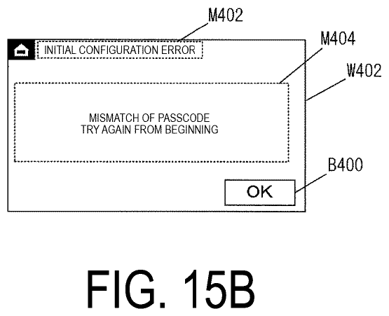

FIGS. 15A and 15B are diagrams illustrating an example of a message displayed to the user as a result of operation of the image forming device 10 according to the present embodiment.

FIG. 15A is a diagram illustrating an example of a display screen W400 displayed on the display 140 of the image forming device 10. The display screen W400 is a diagram illustrating an example of a display screen including a message displayed to the user in a case where the controller 100 performs the initial configuration without involving the network or the like, for example, at the time of initial activation of the MFP in the factory shipment state or based on the selection by the user. The display screen W400 displays a message M400 for prompting input of the administrator password and an OK button B400. Further, an area R400 of the display screen W400 displays an input frame F400 into which the administrator password is input and an input frame F402 for confirming the administrator password. At this time, when the user selects the OK button B400, the display screen W400 transitions to display, for example, the display screen W100 of FIG. 7A.

Note that, in the present embodiment, the password input into each input form is displayed on the display screen. However, for example, the input password may be hidden in such a manner as not to be recognized on the display screen. Specifically, the password may be replaced with another character such as “*”, which is displayed. The display screen may display a switching button that allows the user to switch between display of the password and hiding of the password.

FIG. 15B is a diagram illustrating an example of a display screen W402 displayed on the display 140 of the image forming device 10. The display screen W402 is a diagram illustrating an example of a display screen including a message that is displayed by the controller 100 to the user in a case where the connection information such as the passcode included in the second code information does not match the connection information included in the first code information. The display screen W402 displays a message M402 notifying the user of an error and an OK button B400. Further, the display screen W402 displays a message M404 notifying the user of mismatch of the passcode. At this time, when the user selects the OK button B400, the display screen W402 transitions to display, for example, the display screen W100 of FIG. 7A.

### 4.3 Effects and the Like

As described above, the present embodiment can provide a secure information processing apparatus (for example, wireless equipment using a wireless LAN or the like) that prevents leakage of the configuration items and configuration values belonging to the necessary configurations.

Since whether a handshake with the mobile terminal device is possible can be determined, an information processing apparatus can be provided that, for example, prevents erroneous scanning of code information or the like that is unrelated to the initial configuration.

### 5. Fifth Embodiment

Hereinafter, a fifth embodiment will be described. In the fifth embodiment, the first code information includes, for example, information related to the devices. The fifth embodiment allows information related to the configuration items required for the initial configuration of the information processing apparatus using the mobile terminal device 20 or the terminal device 30 to be acquired from a server device or the inside of an application via the network.

For the fifth embodiment, the same hardware and software configurations between the first embodiment and the fifth embodiment will not be described, and differences from the first embodiment will be focused on.

### 5.1 Processing Flow

### 5.1.1 Initial Configuration Processing

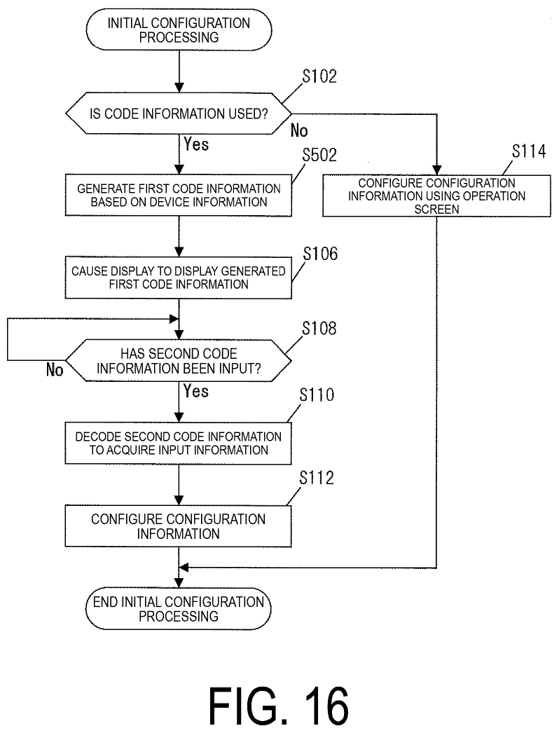

FIG. 16 is a diagram for describing a flow of processing according to the present embodiment. FIG. 16 substitutes for FIG. 5 for the first embodiment. S502 is executed instead of S104 in FIG. 5.

The controller 100 generates the first code information based on device information (S502). The device information is unique information identifying the image forming device 10. The device information may include a model name (model number, series name, or the like) of the image forming device 10. The device information may include information related to firmware (version and the like) in order to identify the image forming device 10. The unique information identifying the image forming device 10 is not limited to hardware, and may be information related to software. For example, the device information may include the type and version of an operating system running in the image forming device 10, the type and version of an application running in the image forming device 10, and the like. For example, the controller 100 may acquire the device information by referring to information stored in a system management area secured in the storage 110, a ROM 120, or the like.

### 5.1.2 Terminal Input Processing

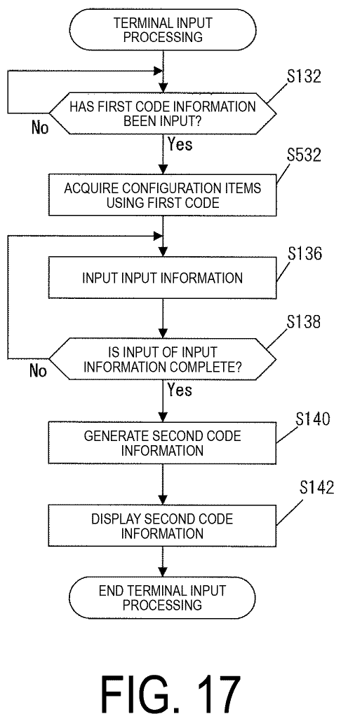

FIG. 17 is a diagram for describing a flow of processing according to the present embodiment. FIG. 17 substitutes for FIG. 6 for the first embodiment. S532 is executed instead of S134 in FIG. 6.

The controller 200 acquires the configuration item information using the first code information (S532). Here, the controller 200 acquires the configuration item information based on the device information acquired by decoding the first code information, for example.

For example, the controller 200 can acquire the device information and the configuration item information corresponding to the device information from the external server device via the communicator 270. For example, the controller 200 transmits the device information to an external server device. For example, the server device searches the database using the device information as a key and extracts the configuration item information. Then, the server device transmits the configuration item information to the mobile terminal device 20. Here, by receiving the configuration item information from the server device, the controller 200 may generate a display screen into which the configuration values of the configuration items can be input. The controller 200 may receive, from the server device, information related to a display screen on which configuration values of configuration items can be input, and display the information by a browser application.

The mobile terminal device 20 may store, in the storage 210, a database including information including the device information and the configuration item information associated with each other. Based on the acquired device information, the controller 200 may search the database to acquire the device information instead of transmitting the device information to the server device.

In the above-described processing, the device information is included in the first code information. However, the device information may instead be information indicating a URL of a web page indicating a display screen on which configuration values can be input.

According to the present embodiment, the two dimensional code or the character string displayed on the display screen by the image forming device 10 includes information obtained by decoding the device information. Therefore, when the user causes the mobile terminal device 20 to scan the two dimensional code or the character string displayed on the display screen of the image forming device 10, the controller 200 of the mobile terminal device 20 can display a screen on which configuration values are input based on the information stored in the external server device, or the information stored in the application, based on the device information. For example, by using the web browser application, the mobile terminal device 20 can be used to input configuration values without the need to install a special application.

### 5.2 Effects and the Like

As described above, according to the present embodiment, the mobile terminal device 20 can configure or change the configuration values in the system configuration of the image forming device 10 based on the device information, which is unique information for identifying the image forming device 10. The server device or the application can manage the configuration values for the image forming device 10, and the configuration values can be flexibly configured in the mobile terminal device 20 according to the image forming device 10.

### 6. Variations

The disclosure is not limited to the embodiments described above and can be changed in various manners.

In other words, embodiments obtained by combining technical mechanisms appropriately changed without departing from the gist of the disclosure are also included in the technical scope.

In the above-described embodiments, the image forming device has been described as an example of the information processing apparatus. However, the disclosure is also applicable to other information processing apparatuses. For example, an example of the information processing apparatus may be a smartphone or a tablet. The information processing apparatus may be a home appliance (for example, an air conditioner, a refrigerator, a television, or the like) equipped with an IoT function. The information processing apparatus is not limited to a stationary device, and may be a portable device or an in-vehicle device, for example. For example, the in-vehicle device may be a device such as a car navigation system.

Although the above-described embodiments have been separately described for convenience of description, the embodiments can be combined and executed within an allowable range. The right of any of the technologies described herein is intended to be acquired through amendment, divisional application, or the like.

The programs running on each device in the embodiments are programs for controlling a CPU or the like (programs for causing a computer to function) to implement the aforementioned functions in the embodiments. Information handled by these devices is temporarily accumulated in a transitory storage device (for example, a RAM) at the time of processing, is then stored in a storage device such as any of various ROMs or an HDD, and is read, corrected, and written by the CPU as needed.

The recording medium storing the programs may be any of a semiconductor medium (for example, a ROM, a non-volatile memory card, or the like), an optical recording medium or a magneto-optical recording medium (for example, a Digital Versatile Disc (DVD), a Compact Disc (CD), a Blu-ray (trade name) Disc (BD) or the like), a magnetic recording medium (for example, a magnetic tape, a flexible disk, or the like), and the like.

In a case where the programs are distributed to the market, the programs can be stored and distributed in a portable recording medium, or can be transferred to a server computer connected via a network such as the Internet. In this case, it is a matter of course that the storage device of the server device is also included in the disclosure.

Instead of being stored in the device, the above-described data may be stored in an external device and appropriately called. For example, the data may be stored in a Network Attached Storage (NAS) or may be stored on a cloud.

It should be noted that the scope of the disclosure is not limited to the configurations explicitly described herein, and a combination of technologies disclosed herein is also included in the scope thereof. Configurations of the disclosure sought to be patented are set forth in the appended claims, but configurations not recited in the claims are not intended to be excluded from the technical scope.

In the above-described specification, the descriptions “in a case where . . . ” and “when . . . ” are described as examples, and the configuration is not limited to the described contents. Configurations not indicated by the descriptions “in a case where . . . ” and “when . . . ” are also disclosed to the extent that the configurations are obvious to a person skilled in the art, and the rights thereof are intended to be acquired.

The processing and the flow of data have been described herein with order, but the order thereof is not limited to the described order. For example, a configuration in which processing is partly removed or the order is rearranged is also disclosed, and the right thereof is intended to be acquired.

Although the functions described in the embodiments are described as being performed in the respective devices, the functions may be implemented in one device or using an external server.

Each functional block or various features of the device used in the above-described embodiments may be implemented or performed by an electric circuit, for example, an integrated circuit or multiple integrated circuits. An electric circuit designed to perform the functions described herein may include a general-purpose processor, a digital signal processor (DSP), an application specific integrated circuit (ASIC), a field programmable gate array (FPGA) or other programmable logic device, discrete gate or transistor logic, discrete hardware components, or a combination thereof. A general-purpose processor may be a microprocessor, or any known processor, controller, microcontroller, or state machine. The above-described electric circuit may be constituted by a digital circuit or an analog circuit. In addition, in a case where an integrated circuit technology that replaces the current integrated circuit becomes available due to advancement of the semiconductor technology, one or more aspects of the disclosure can use a new integrated circuit based on the new integrated circuit technology.

### Description of Symbols

10 Image forming device
20 Mobile terminal device
30 Terminal device
100, 200 Controller
110, 210 Storage
120, 220 ROM
130, 230 RAM
140, 240 Display
150, 250 Operation inputter
160 Image former
165 Image scanner
170, 270 Communicator
180 Code information acquirer
260 Imaging unit

1. An information processing apparatus comprising:
a storage that stores system configuration information;
an acquirer that acquires input information generated in a terminal device; and
one or more controllers that perform system configuration processing based on the system configuration information, wherein
based on the input information acquired from the terminal device, the one or more controllers store the system configuration information and perform the system configuration processing.

2. The information processing apparatus according to claim 1, wherein
the storage stores a configuration value for per item as the system configuration information, and
the one or more controllers read at least the configuration value from the input information and store the configuration value in the configuration value of the system configuration information.

3. The information processing apparatus according to claim 2, wherein
the one or more controllers also read items from the input information, and based on the read items, store the configuration values read from the input information in the items of the system configuration information.

4. The information processing apparatus according to claim 2, wherein
the items include a first item related to a configuration necessary for an initial configuration of the information processing apparatus and a second item related to any other configuration, and
the one or more controllers read, from the input information, a configuration value corresponding to at least the first item, and store the configuration value in the configuration value of the system configuration information.

5. The information processing apparatus according to claim 4, wherein
the first item is at least one of a configuration item related to an administrator password and an item related to a network configuration.

6. The information processing apparatus according to claim 1, wherein
the input information is information of an encoded figure, and
the acquirer acquires the input information using an optical scanning scheme.

7. The information processing apparatus according to claim 1, wherein
the one or more controllers output, to the terminal device, information based on the system configuration information used by the terminal device to generate the input information.

8. The information processing apparatus according to claim 1, wherein
the one or more controllers output, to the terminal device, information used by the terminal device to connect to the information processing apparatus.

9. The information processing apparatus according to claim 1, wherein the one or more controllers output, to the terminal device, unique information for identifying the information processing apparatus.

10. A configuration method comprising:
a storage step of storing system configuration information;
an acquisition step of acquiring input information generated in a terminal device; and
a control step of performing system configuration processing based on the system configuration information, wherein
the control step includes storing the system configuration information and performing the system configuration processing, based on the input information acquired from the terminal device.
